(19) United States
(12) Patent Application Publication
(10) Pub. No.: US 2009/0182904 A1
(43) Pub. Date: Jul. 16, 2009

(54) System and Method for Providing Peripheral Device Functionality

(75) Inventors: James Huston, Boulder Creek, CA (US); William Schupp, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 11/972,578

(22) Filed: Jan. 10, 2008

(51) Int. Cl. G06F 3/00

(52) U.S. Cl. 710/11

(57) ABSTRACT

An application program is stored in a peripheral device memory, and then transferred to a host device upon being connected using a plug-and-play communication protocol. The application program is executed by the host device to provide peripheral device functionality using an on-screen display of the host device. This peripheral device functionality may include control of the peripheral device, accessing media content stored on or by the connected peripheral device, and accessing security features available to the peripheral device. In this fashion, the host device, despite being a closed system, may be used as a single integrated interface for controlling or accessing any connected peripheral device.

### FIELD OF THE INVENTION

The present invention relates in general to peripheral device functionality, and in particular to systems and methods for providing peripheral device functionality through a host system interface.

### BACKGROUND

So-called “plug-and-play” peripheral devices have existed for many years. In general, such devices contain either read-only memory (ROM) drivers for personal computer (PC) bus connections, or they conform to a known communication standard that a host's operating system will readily recognize and configure itself to operate. In addition, Application Program Interfaces (“APIs”) have been used to connect peripheral devices to modern PC systems.

However, in the context of televisions and other such multimedia electronic devices, such systems are closed systems in that they are not hardware upgradeable—the microprocessor and memory remains fixed for the life of each model. The features are set according to available resources and market surveys, determining a “most common denominator” set of features that appeal to the widest range of buyers. Therefore, applications on such electronic devices remain static utilizing system resources and occupying non-volatile memory, whether the consumer uses them or not.

Of course, the main feature of all televisions is to receive and display video content from broadcast, cable, satellite, or other external device such as personal video recorders (PVRs), digital video disk (DVD) players and set-top boxes (STBs). Some televisions also have applications that can display pictures or play music files from a “pluggable” memory device. Showing pictures or playing music is also sometimes allowed by connecting a peripheral device, such as a digital camera, video camera or MP3 player. However, controlling such peripheral devices is a cumbersome process at best. While most televisions come equipped with a remote control that also control of other components, controlling such components requires using a multitude of buttons, controller modes, and different (device-sourced) on-screen displays.

Thus, what is needed is a system and method for providing peripheral device functionality through the host system's interface.

### BRIEF SUMMARY OF THE INVENTION

Disclosed and claimed herein are systems and methods for providing peripheral device functionality. In one embodiment, a method includes storing an application program in a peripheral device memory, detecting a connected host device and transferring the application program from the peripheral device memory to a host device memory. The method further includes executing the application program by the host device, and then providing peripheral device functionality using a host device interface.

In another embodiment, a method for providing peripheral device functionality includes detecting that a host device is connected to a peripheral device interface, establishing a communication link with the host device, and transferring an application program to a host device memory via the communication link. The method then includes receiving a command from the application program, where the application program is being executed by the host device and where the command was provided using a host device interface.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a block diagram of a system configured in accordance with one embodiment of the invention;

FIG. 2 is a block diagram of a system configured in accordance with another embodiment of the invention;

FIG. 3 is one embodiment of a process for carrying out one or more aspects of the invention; and

FIG. 4 is another embodiment of a process for carrying out one or more aspects of the invention.

### DETAILED DESCRIPTION OF EXEMPLARY EMBODIMENTS

### Disclosure Overview

One aspect of the present disclosure relates to storing an application program in a nonvolatile memory of a peripheral device. Upon connecting the peripheral device to a host device (e.g., television), a communication link between the peripheral device and host device is established using, for example, a plug-and-play communication protocol. Thereafter, the peripheral device may transfer the application program to the host device, which in one embodiment is to a volatile memory.

As will be explained in more detail herein, the application program may then be executed by the host device to provide peripheral device functionality using a standard host device interface, such as the host device's native on-screen display. This peripheral device functionality may include control of the peripheral device, accessing media content stored on or by the connected peripheral device, and accessing security features available to the peripheral device. In this fashion, the host device, despite being a closed system, may be used as a single integrated interface for controlling or accessing any connected peripheral device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

### Exemplary Embodiments

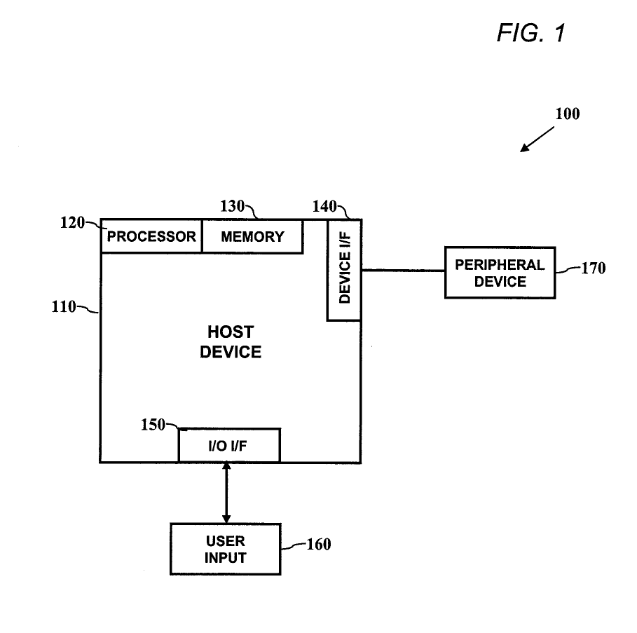

The present disclosure relates to providing peripheral device functionality using a host system interface. To that end, FIG. 1 depicts a system 100 configured in accordance with the principles of the invention. In particular, system 100 includes a host system 110 (e.g., television). The host device 110 includes a processor 120, and a memory 130 which may include both volatile and nonvolatile portions. In one embodiment, the host device 110 is a closed system which is not readily hardware upgradeable. Such a closed system may also be characterized as a system which does not allow alteration of the operating software and/or to extend the hardware that is directly accessible to the processor, such as random access memory.

Continuing to refer to FIG. 1, host device 110 further includes an input/output user interface 150 configured to communicate with a user input device 160, such as a wireless remote control device. While in one embodiment, the interface 150 is an infrared or radio frequency interface with which a wireless remote control may communicate, it may also comprise a series of buttons, switches or other known user controls for inputting user commands.

The host device 110 is also depicted as including a device interface 140, which may be configured to establish a communication link with peripheral device 170. While peripheral device 170 may be a DVD player, PVR, STB or home theater system, it should be appreciated that it may any consumer electronic device capable of establishing a communication link with the host device 110.

In certain embodiment, the device interface 140 may be based on a standard protocol, such as the Universal Serial Bus (USB) or the IEEE 1394 interface protocol. In that regard, the peripheral device 170 may be a so-called plug-and-play device in which the host device 110 and the peripheral device 170 perform an initial communication protocol handshake upon being physically connected. Once this initial exchange of data is completed in accordance with the applicable communication protocol, a persistent communication link is established between the host device 110 and the peripheral device 170. Thereafter, and as described in more detail below, user control functionality of the peripheral device 170 may be provided using a host device interface (not shown), such as an on-screen display (OSD).

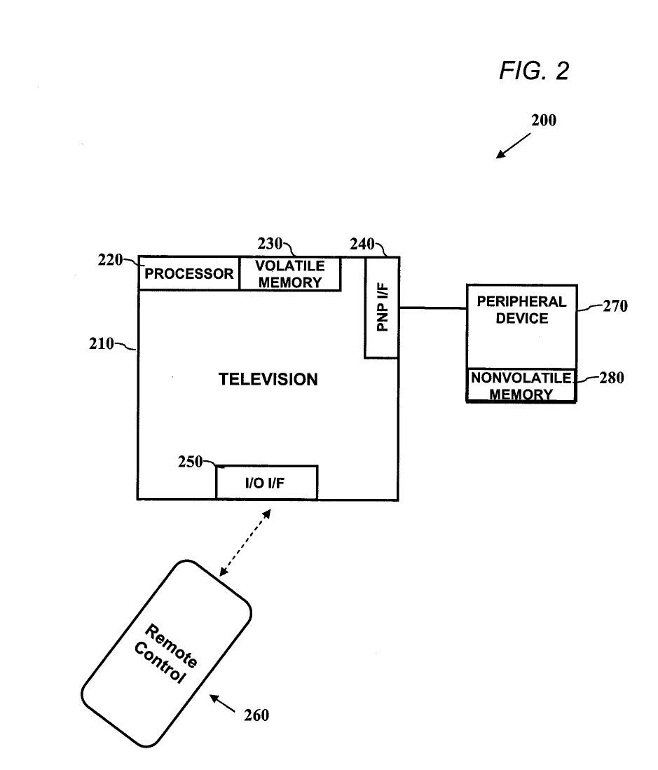

Referring now to FIG. 2, depicted is another embodiment of a system 200 configured in accordance with the principles of the invention. In particular, the host device of system 200 is television 210. The television 210 includes a processor 220 and volatile memory 230. It should further be appreciated that the television 210 may also include nonvolatile memory (not shown) for storage of a corresponding operating system.

Continuing to refer to FIG. 1, television 210 further includes an input/output user interface 250 configured to communicate with remote control 260. Additionally, the interface 250 may comprise a series of buttons, switches or other known user controls for inputting user commands into the television 210.

The television 210 is also depicted as including a plug-n-play interface 240, such as a USB or IEEE 1394 interface. Peripheral device 270, which may be a DVD player, PVR, STB or home theater system, is configured to be electrically connected to the television 210 via the plug-n-play interface 240. Following an initial communication protocol handshake between the television 210 and the peripheral device 270, a persistent communication link may be established there between.

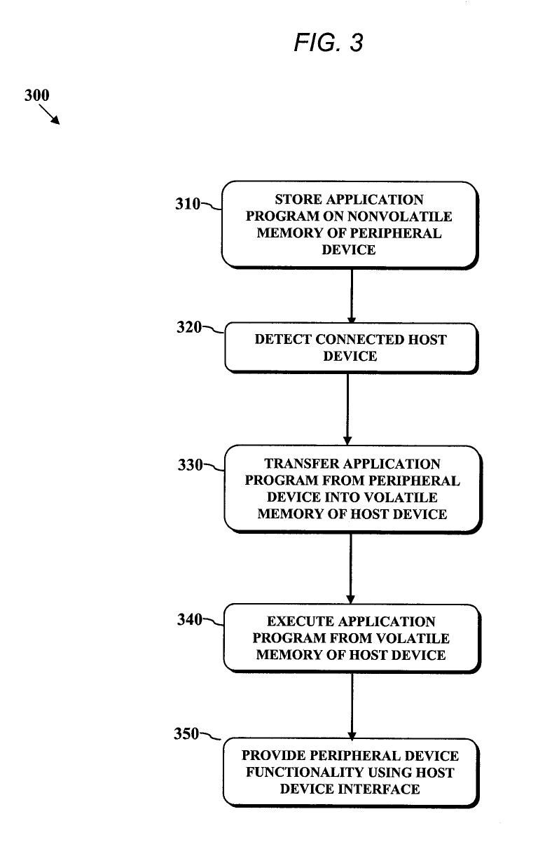

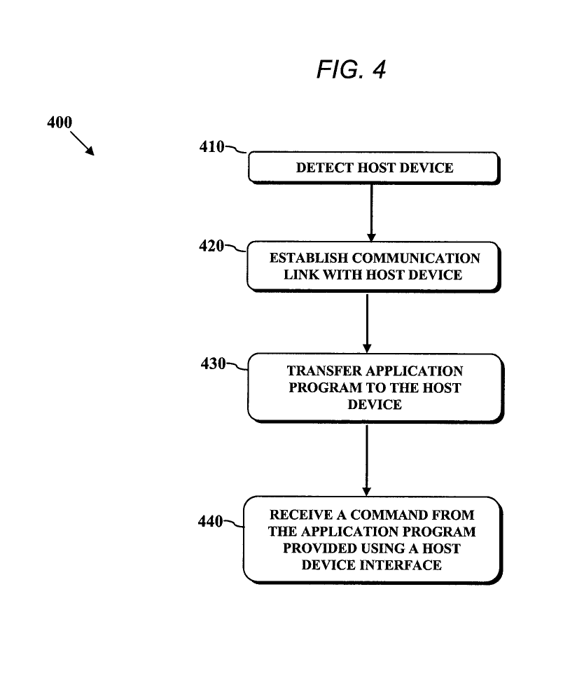

Functionality over (or relating to) the peripheral device 270 may be provided using the television's 210 standard OSD. In one embodiment, an device-specific application program is pre-loaded in a nonvolatile memory 280 of the peripheral device 270. For example, the manufacturer of the peripheral device 270 may include the device-specific application within the device's non-volatile memory. In that fashion, the user would never have to install it on any system. Multiple versions of the application program may be present to support different host operating systems. In another embodiment, the application programs could also be updated on the device by earlier versions of the application (when internet connection or additional storage medium is available). As will be described below with reference to FIGS. 3 and 4, this application program may be transferred to and executed by the television 210 to provide user control and related functionality of the peripheral device 270 using the television's 210 standard OSD display.

FIG. 3 is one embodiment of a process 300 for carrying out one or more aspect of invention. In particular, process 300 begins at block 310 where a device-specific application program is stored on a nonvolatile memory of the subject peripheral device (e.g., peripheral device 170 or 270). In one embodiment, this application program includes computer executable program code for controlling the peripheral device, or otherwise providing some functionality relating to the peripheral device. The storing operation of block 310 may be performed at the time of manufacture, or at any point thereafter.

Process 300 may then continue to block 320 where a connected host device (e.g., host device 110 or 210) is detected. The operation of block 320 may follow the physical coupling of the subject peripheral device to the host device via a device interface (e.g., device interface 140 or 240), which in one embodiment may be any plug-n-play interface (e.g., USB, IEEE 1394, etc.).

Once the host device is detected, it should be appreciated that a standard protocol handshake may be performed before a persistent communication link is established between the peripheral and host devices. Regardless of the exact sequence required to establish the communication link, once such a link is established process 300 may continue to block 330 where the application program may be transferred from the peripheral device to a memory (e.g., memory 130 or 230) of the host device via the established communication link. In certain embodiments, the application program may be transferred to a volatile memory of the host device.

Once the application program has been transferred to the host device, process 300 continues to block 340 where the host device may execute the application program (e.g., using processor 120 or 220). In one embodiment, the host device executes the application program directly from its volatile memory.

It should be appreciated that a simple extension to the host's operating system may be needed to identify the presence of the device's application availability and either load/launch the program or ask the user whether they want this to occur. The same extension may monitor the peripheral device connection and close the application when the peripheral device is removed. In certain embodiments, the application program itself may not be stored in the host device's non-volatile memory, but rather only be stored in the host's volatile memory (e.g., random access memory) for the duration of the device connection.

In one embodiment, the aforementioned operating system extensions may include additional peripheral device communication protocols (e.g., Universal Serial Bus, IEEE 1394, etc.). Such protocols may also include customized additional fields that can be exclusive to each device, allowing a manufacturer (or group) to establish new protocols and features that may not have been contemplated by the specific adopted protocol. In certain embodiments, such operating system extensions may rely on these additional fields to identify devices that have loadable application code and/or what communication protocol should be utilized. In this fashion, once the application is loaded, the application itself may manage the device through the given protocol.

In this fashion, the host device may not require specific knowledge of the peripheral device's capabilities or any other device-specific data since the device would appear as a standard communication or storage device. Certain embodiments of the invention may enable new peripheral devices, with novel features or otherwise, to be fully supported (as long as sufficient host memory resources are available) even though such device may not have been available when the host device was manufactured.

Continuing to refer to FIG. 3, once the application program is executed by the host device, process 300 may continue to block 350 where peripheral device functionality may be provided to a user via the host device's standard interface (e.g., native OSD). That is, in one embodiment, the visual elements (e.g., icons, menus, etc.) would be displayed to the user in an integrated fashion with the television's standard OSD, thereby enabling the user to interact with the connected peripheral device using the standard user input means (e.g., remote control, television buttons, etc.). For example, the host devices user input interface (e.g., I/O I/F 150 or 250) may be used to interact with the connected peripheral device using the host device as a single integrated interface. While in certain embodiments, such peripheral device functionality may include control of the peripheral device, in other embodiments it may also include accessing media content stored on or by the connected peripheral device. In this fashion, the host device, despite being a closed system, may be used as a single integrated interface for controlling or accessing any connected peripheral device.

In the context of providing control functionality for an attached digital or video camera, the application program may be usable to provide full control of the camera for playback of audio/video content. The application program may also be configured to provide control of the camera for real-time or time-lapse recording (e.g., “nanny-cam” functionality).

If the host device (e.g., television) has an internet connection, a teleconferencing feature could also be provided by the application program. For example, during a teleconference call, audio/video content captured by the attached camera could be selectively injected into the outgoing data/voice stream.

If the host device (e.g., television) also has a DVD recorder or DVR connected, a background archival feature could be enabled. This may allow the user to backup or copy their camera's content to other connected devices using only the host device interface.

Similar peripheral device functionality may also be provided for other connected portable and peripheral devices, such as providing secure access to online store purchase and downloads for MP3 players, electronic book readers, and DVD recorders.

It should further be appreciated that peripheral devices may even be manufactured without any built-in OSD hardware since all on-screen control can be accomplished by the host device (e.g., television) using the peripheral device's application program, thereby resulting in lower manufacturing costs and improved (unified) user experience.

Referring now to FIG. 4, depicted is one embodiment of a process 400 for carrying out one or more aspect of the invention using a peripheral device (e.g., peripheral device 170 or 270). In particular, process 400 begins at block 410 where the peripheral device detects a connected host device (e.g., host device 110 or 210). Once detected, process 400 continues to block 420 where a communication link with the host device is established. In one embodiment, the communication link may be established following a standard protocol handshake, such as is the case for a USB or IEEE 1394 connection.

Regardless of the exact sequence required to establish the communication link, once such a link is established, process 400 may continue to block 430 where an application program may be transferred from the peripheral device to a memory (e.g., memory 130 or 230) of the host device via the established communication link. In certain embodiments, the application program may be transferred to a volatile memory of the host device. It should further be appreciated that this application program may include computer executable program code for controlling the peripheral device, or otherwise providing some functionality relating to the peripheral device.

Once the application program has been transferred to the host device, process 400 continues to block 440 where the peripheral device may receive a command or general instruction from the application program, which may be executing on the host device (e.g., using processor 120 or 220). In certain embodiments, the command received at block 440 may have been provided by a user via the host device interface, such as the host devices native OSD. In one embodiment, this command may be used to operate or otherwise access some functionality of the peripheral device. In this fashion, the host device, despite being a closed system, may be used as a single integrated interface for controlling or accessing any connected peripheral device.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for providing peripheral device functionality comprising:
storing an application program in a peripheral device memory;
detecting a connected host device;
transferring the application program from the peripheral device memory to a host device memory;
executing the application program by the host device; and
providing peripheral device functionality using a host device interface.

2. The method of claim 1, wherein detecting the connected host device further comprises establishing a communication link with the connected host device using a standard plug-in-play protocol.

3. The method of claim 1, wherein the connected host device is a display device.

4. The method of claim 1, wherein transferring the application program comprises transferring the application program from the peripheral device memory to a volatile memory of the connected host device.

5. The method of claim 1, wherein providing peripheral device functionality comprises providing control functionality of the peripheral device using an on-screen display of the connected host device.

6. The method of claim 1, wherein providing peripheral device functionality comprises providing security functionality for the peripheral device using the host device interface.

7. The method of claim 6, wherein the security functionality comprises at least one of digital right management, encryption and user validation.

8. The method of claim 1, wherein providing peripheral device functionality comprises providing access to media content on the peripheral device using the host device interface.

9. A peripheral electronic device comprising:
a peripheral device memory having an application program stored therein;
an peripheral device interface for coupling to a device interface of a host device; and
a processor configured to,
detect the host device when connected to the peripheral device interface;
establish a communication link with the host device;
transfer the application program to a host device memory via the communication link;
receive a command from the application program, wherein the application program is being executed by the host device and wherein the command was provided using a host device interface.

10. The peripheral electronic device of claim 9, wherein the host device is a display device.

11. The peripheral electronic device of claim 9, wherein the processor is configured to establish the communication link using a standard plug-and-play protocol.

12. The peripheral electronic device of claim 9, wherein the processor is configured to transfer the application program to a volatile memory of the host device.

13. The peripheral electronic device of claim 9, wherein the host device interface comprises an on-screen display of the host device.

14. The peripheral electronic device of claim 9, wherein the command corresponds to a security feature for the peripheral device.

15. The peripheral electronic device of claim 14, wherein the security feature comprise at least one of digital right management, encryption and user validation.

16. The peripheral electronic device of claim 9, wherein the command corresponds to a request to access media content on the peripheral device using the host device interface.

17. A method for providing peripheral device functionality comprising:
detecting that a host device is connected to a peripheral device interface;
establishing a communication link with the host device;
transferring an application program to a host device memory via the communication link; and
receiving a command from the application program, wherein the application program is being executed by the host device and wherein the command was provided using a host device interface.

18. The method of claim 17, wherein establishing the communication link comprises establishing a communication link having a standard plug-and-play protocol.

19. The method of claim 17, wherein the host device is a display device.

20. The method of claim 17, wherein transferring the application program comprises transferring the application program to a volatile memory of the host device.

21. The method of claim 17, wherein the host device interface comprises an on-screen display of the host device.

22. The method of claim 17, wherein receiving the command comprises receiving the command from the application program where the command corresponds to a peripheral device security feature.

23. The method of claim 22, wherein the security feature comprise at least one of digital right management, encryption and user validation.

24. The method of claim 17, wherein receiving the command comprises receiving the command from the application program where the command corresponds to a request to access media content.
